(19) United States
(12) Patent Application Publication
(10) Pub. No.: US 2011/0109119 A1
(43) Pub. Date: May 12, 2011

(54) Aesthetically enhanced vehicle cover

(76) Inventors: Melita Kohanteb-Shirazian, Woodland Hills, CA (US); Edmound David Shirazian, Woodland Hills, CA (US)

(21) Appl. No.: 12/927,218

(22) Filed: Nov. 10, 2010

Related U.S. Application Data
(60) Provisional application No. 61/280,865, filed on Nov. 10, 2009.

(51) Int. Cl. B60J 11/00

(52) U.S. Cl. 296/136.07

(57) ABSTRACT

A vehicle cover comprises features that provide a distinctive look of an animate and/or an inanimate object when the vehicle cover is deployed. The features maybe components or surface ornamentation. The vehicle cover, when deployed, displays a variety of fun and unique animal shapes or other distinctive features such as floral designs, characters or other kinds of aesthetic enhancement.

### CROSS REFERENCE TO RELATED APPLICATIONS

The present patent application is a formalization of a previously filed co-pending provisional patent application entitled “Animal Automobile Cover,” filed Nov. 10, 2009, as U.S. patent application Ser. No. 61/280,865 by the inventor(s) named in this application. This patent application claims the benefit of the filing date of the cited provisional patent application according to the statutes and rules governing provisional patent applications, particularly 35 USC §119 and 37 CFR §1.78. The specification and drawings of the cited provisional patent application are specifically incorporated herein by reference.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

This invention is related to a vehicle cover including method of manufacture and use of same. In particular, a vehicle cover comprises one or more features that, when deployed, projects a distinctive image of a human, animal, or a plant.

### BACKGROUND

The present invention relates to a vehicle cover such that when it is deployed it projects a distinctive image of something interesting other than the conventional car cover. The available vehicle covers found in the prior art, although highly functional, are typically produced in dull, boring shades of beige or gray, are plain, and without any aesthetic interest. The goal of the current invention is to produce the same, if not better, protection for all kinds of vehicles with a lot more fun and personality.

This invention provides the consumer an alternative to the conventional car, boat, motorcycle, RV, bus and small aircraft covers by virtue of the variety of its unique shapes and features. These unique features may be cut or shaped into the cover's pattern, designed onto it, incorporated into it, or otherwise attached to the cover. The vehicle cover of the present invention would be manufactured in a variety of larger-than-life animal, insect, floral and other designs and shapes to accommodate different vehicles which the cover protects. For example, among the many representations possible, a boat cover could take on the look or shape of a whale or shark; a single-engine plane could appear as an eagle or pterodactyl; a Volkswagen Beetle could become a ladybug; a Ford Mustang could depict its equine inspiration; and an RV or bus could be transformed into a brontosaurus or a bear.

Widely accepted and everyday methods and techniques may be used to achieve the shape of the cover, such as by using stitching, wires, piping, zippers, buttons, Velcro or other methods, depending on the design, size and form of the cover. Regardless of shape, size, or design, all the covers maybe secured to the vehicle by a triple-stitched, elastic border with elasticized drawstrings, bands, or expandable rings to loosen and tighten the cover, and may include ropes, zippers, Velcro, rubber bands or other simple yet effective methods to hold it in place.

Although various covers have been proposed, they do not provide solutions to the existing limitations in providing a vehicle cover with a distinctive look. For example, the Webber patent application, U.S. Pat. App. No. 20070252406 entitled “Car Cover and Deployment System Therefor” discloses a protective flexible car cover that is attachable to and detachable from a foldable deployment rod, which facilitates deploying and removing the car cover from a vehicle. The attachment of the car cover to the deployment rod is effected by fasteners. The car cover has magnets or weights around its periphery to help hold the cover in place while being deployed and after deployment. Additional panels on the underside of the car cover and at the rear of the car cover are provided which can be held in place by the side doors of the vehicle or by the trunk lid. However, the Webber invention does not provide for a vehicle cover that projects a distinctive image such as those described here.

The Pacheco patent, U.S. Pat. No. 7,311,112, entitled “Collapsible, Portable, Easily Deployed Car Cover” discloses a portable collapsible car cover assembly which includes a collapsible hollow housing with exit sheet exit apertures, which housing has a compact collapsed configuration and an extended deployed configuration, a base which includes a suction cup for fastening the assembly to the roof of a car, which housing contains sheets of protective material wound around rollers when the car cover assembly is collapsed and stored, and wherein the sheets are unwound to cover the trunk, passenger compartment, and hood when the assembly is fully deployed, several elements for attaching the distal end of the sheets of protective material to a car, and at least two security lines for attaching the housing to the car as a theft deterrent. However, the Pacheco car cover does not provide features that would make it to appear as an animate or inanimate object.

The Yang patent, U.S. Pat. No. 7,036,867, entitled “Car Cover” discloses a car cover which includes a top piece and at least two-section side pieces. The two-section side pieces can be fabricated from side pieces and inclined pieces, edges of which are designed with non-straight convex arc line cut edges, and horizontally protruding regions are formed after joining the edges. The two-section side pieces can also be fabricated from front side pieces and rear side pieces, edges of which are designed with non-straight convex arc line cut edges, and vertically protruding regions are formed after joining the edges. Space within the outward expanding, curved protruding regions is used to contain rear-view mirrors of the car body when covering the car body with the car cover, thereby achieving a structure that is easy to manufacture and reduces manufacturing cost. Moreover, the car cover has universal suitability for many different car models and provides the convenience of covering and uncovering. However, the Yang car cover when deployed does not look like a human, animal, or plant.

The Ostrom et al. patent, U.S. Pat. No. 4,738,293, entitled “Ball Hitch Cover” discloses a decorative cover unit for the ball hitch of a towing vehicle to cover the ball when not in towing use. The cover unit includes a decorative head portion in various shapes and forms and a ball receiving and protective portion including an adjustable member receivable therein such that the unit may cover the commercially available and recognized sizes of ball hitches. The basic unit includes the decorative head portion and a ball covering portion of a first size to be received over a two inch ball hitch with an insert to reduce the internal size of the unit to receive a ball of 1⅞ inch diameter. The primary unit provides a certain degree of flexibility to frictionally capture the ball and the insert unit provides frictional capturing capabilities to the primary unit and to a ball of the smaller diameter. The insert is of a length to provide proper frictional contact and is of a length to provide holding contact to the ball hitch. However, it does not provide for a vehicle cover as the vehicle cover of the present invention.

The vehicle cover of the present invention provides a creative and unique vehicle cover that would set it apart from other covers by attaching or incorporating additional features into the cover to make it more attractive and entertaining while serving its true purpose to protect the vehicle from both weather and break-ins.

### SUMMARY

In one aspect, a vehicle cover is disclosed which includes one or more feature wherein the one or more feature provides a distinctive image of at least one of an animate and inanimate object when the vehicle cover is deployed.

According to one preferred embodiment, the vehicle comprises one of a bicycle, car, motorcycle, train, ship, boat, aircraft, watercraft, sailcraft, hovercraft, and spacecraft.

According to one preferred embodiment, the animate object comprises at least one of a human, animal, and plant. Preferably, the human comprises a celebrity. Preferably, the animal comprises one of a dog, cat, mouse, fish, whale, shark, eagle, ladybug, bear, and dinosaur. Preferably, the plant comprises one of a flower and fruit.

According to one preferred embodiment, the inanimate object comprises a fictitious character. Preferably, the fictitious character comprises a cartoon character. Preferably, the cartoon character comprises one of Tweedy Bird and Sylvester. Preferably, the fictitious character comprises a motion picture character.

According to one preferred embodiment, the one or more feature comprises one or more surface ornamentation. Preferably, the one or more surface ornamentation comprises one or more drawing.

According to one preferred embodiment, the one or more feature comprises one or more component. Preferably, the one or more component comprises at least one of an eye, nose, ear, hand, leg, foot, paw, and tail. Preferably, the one or more component is coupled with the vehicle cover via at least one of stitches, zippers, buttons, and Velcro. Preferably, the one or more component further comprises at least one of wires and piping whereby said one or more component projects outwardly to further enhance the distinctive image.

According to one preferred embodiment, the vehicle cover comprises at least one of a textile, leather, and polymer. Preferably, the at least one of a textile, leather, and polymer is further at least one of UV-resistant, waterproof, and weather-resistant.

In another aspect, a method of making a vehicle cover is disclosed including providing a vehicle cover comprising one or more feature wherein the one or more feature provides a distinctive image of at least one of an animate and inanimate object when the vehicle cover is deployed.

In another aspect, a method of covering a vehicle is disclosed including covering a vehicle with a vehicle cover comprising one or more feature wherein the one or more feature provides a distinctive image of at least one of an animate and inanimate object when the vehicle cover is deployed.

### BRIEF DESCRIPTION OF THE DRAWINGS

FIG. 1 shows two perspective views of a vehicle cover which includes features that give the vehicle cover the distinctive look of an animate object, i.e., a cat, according to a preferred embodiment. The vehicle is a car and the features include both components, such as eyes, nose, ears, mouth, tail, and whiskers, and surface ornamentation, such as lines, shadows, and patterns.

FIG. 2 shows two perspective views of a vehicle cover which includes features that give the vehicle cover the distinctive look of an inanimate object, i.e., a skeleton, according to a preferred embodiment. The vehicle is a motorcycle and the features include both components, such as a skeleton head, which includes eye sockets, mouth with teeth, nose, and a helmet, ribs, hands and kegs, and surface ornamentation, such as lines and shadows.

FIG. 3 shows four perspective views of a vehicle cover which includes features that give the vehicle cover the distinctive look of an inanimate object, i.e., a reptile, such as a crocodile, according to a preferred embodiment. The vehicle is a car and the features include surface ornamentation, such as color paintings.

### DETAILED DESCRIPTION OF THE PRESENTLY PREFERRED EMBODIMENTS

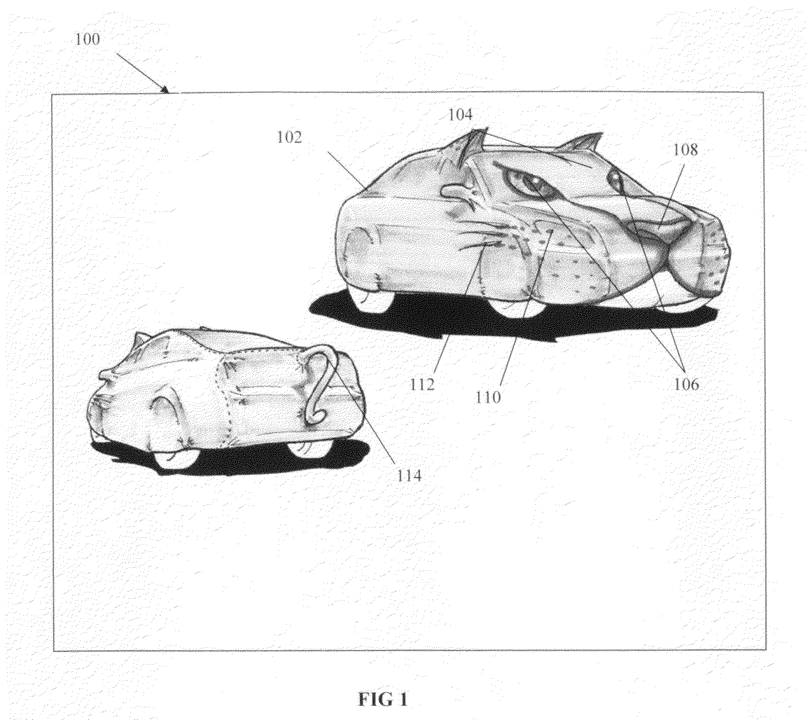

FIG. 1 depicts two perspective views 100 of a vehicle covered with a vehicle cover 102 which, when deployed, projects an image of a cat. The vehicle cover 102 comprises elements and drawing patterns that are associated with those of a cat. In particular, the vehicle cover 102 comprises a pair of ears 104, a pair of eyes 106, a nose 108, whiskers 112, tail 114 and drawing pattern 110 that shows spots/freckles that are distinctively associated with cats.

The vehicle cover of the present invention maybe used to cover a variety of different vehicles such as a bicycle, a car, a motorcycle, a boat, or an aircraft. Furthermore, the vehicle cover of the present invention, when deployed, may take on a variety of different shapes. In this preferred embodiment, the vehicle is an automobile and the vehicle cover 102 has the shape of a cat. However, in other embodiments, the vehicle cover of the present invention maybe constructed so as to project the image of a human, a cartoon character, or a flower. For instance, the vehicle cover maybe made to project the distinctive image of a dog, mouse, fish, whale, shark, eagle, ladybug, bear, or a dinosaur.

The vehicle cover 102 is made from cloth known to artisans of ordinary skill. However, the material used to make the vehicle cover 102 is not limited to textile. Therefore, in other embodiments, the vehicle cover 102 maybe made from leather or polymers. Furthermore, the vehicle cover 102 maybe made from material which has been specially treated or processed and which includes coatings so as to render it UV-resistant, waterproof, or weather-resistant.

According to the present embodiment, the vehicle cover 102 comprises a combination of surface ornamentations and components. In particular, the vehicle cover 102 comprises drawing patterns and elements that make it look like a cat when it is deployed.

The elements 104, i.e., the ears of the cat maybe made separately or cut into the body of the vehicle cover 102. If made separately, the ears 104 maybe attached to the body of the vehicle cover 102 by a variety of means known to artisans of ordinary skill. For instance, the ears 104 may be attached to the body of the vehicle cover 102 via stitches, zippers, buttons, or Velcro. Furthermore, the ears 104 maybe made form the same material as the body of the vehicle cover 102 or from a different material such as polymers. For instance, the body of the vehicle cover 102 maybe made form cloth and the ears 104 maybe made form plastic. As such, the ears 104 would have a higher rigidity than the body of the vehicle cover 102 and thus more distinctive. In one preferred embodiment, the components of the vehicle cover 102 may include other elements such as wires, coils, or pipes so as to make then project outwardly in an effort to make them even more distinctive.

Similar to the ears 104, the other elements of the vehicle cover 102 can be made separately or cut into the design. According to this preferred embodiment, the eyes 106, nose 108, whiskers 112, and tail 114 are made separately and then fastened to the body of the vehicle cover 102 by stitching them to the body of the vehicle cover 102.

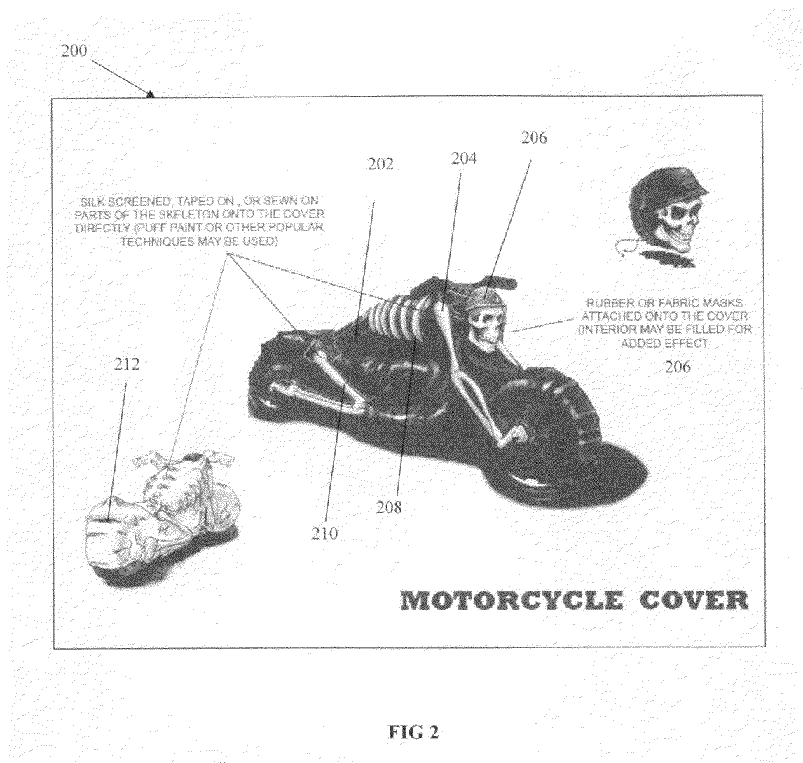

FIG. 2 depicts two perspective views 200 of a vehicle covered with a vehicle cover 202 which, when deployed, gives the distinctive look of a skeleton. The vehicle cover 202 comprises elements and drawing patterns that are associated with those of a human skeleton. In particular, the vehicle cover 202 comprises a human skeleton head 206, which includes eye sockets, mouth with teeth, nose, and a helmet, human skeleton hands 204, human skeleton ribs 208, human skeleton kegs 210, and surface ornamentations 212 that shows drawing patterns that are distinctively associated with a human skeleton.

In this preferred embodiment, the vehicle is a motorcycle and the vehicle cover 202 has the shape of a human skeleton. In this preferred embodiment, the vehicle cover 202 is made from soft and flexible leather and made to be waterproof.

According to the present embodiment, the human skeleton head 206 is made separately and then attached to the body of the vehicle cover 202 via buttons. Furthermore, the human skeleton head 206 includes an inflatable component which maybe pressurized and thus made to protrude outwardly, providing it with a more distinctive look.

The other elements of the vehicle cover 202 can be made separately or cut into the design as mentioned above. According to this preferred embodiment, the human skeleton hands 204, human skeleton ribs 208, human skeleton kegs 210 cut into the design of the vehicle cover 202. Additionally, the surface ornamentations 212 comprise shows drawing patterns that are distinctively associated with a human skeleton.

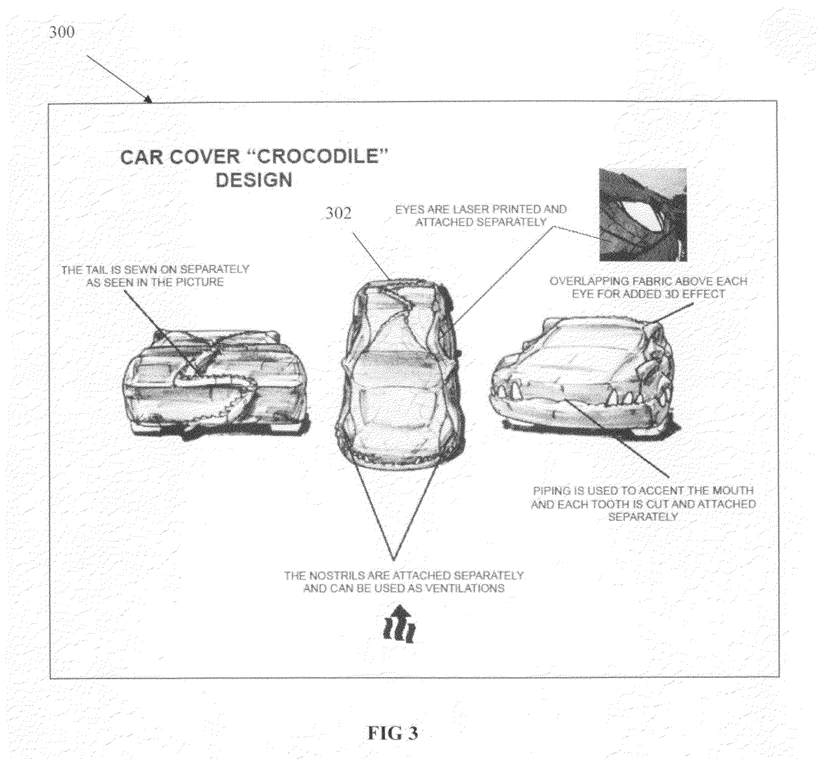

FIG. 3 depicts four perspective views 300 of a vehicle covered with a vehicle cover 302 which, when deployed, gives the distinctive look of a crocodile. According to this preferred embodiment, the vehicle cover 302 comprises only drawing patterns that are associated with those of a crocodile. In particular, the vehicle cover 302 comprises color paintings which would project the distinctive image of a typical crocodile when deployed.

The foregoing discloses a vehicle cover, including methods of manufacture and use, which comprises one or more features that provide a distinctive look of an animate and/or an inanimate object when the vehicle cover is deployed. The features maybe components or surface ornamentation.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A vehicle cover comprising one or more feature wherein the one or more feature provides a distinctive image of at least one of an animate and inanimate object when the vehicle cover is deployed.

2. The vehicle cover of claim 1, wherein the vehicle comprises one of a bicycle, car, motorcycle, train, ship, boat, aircraft, watercraft, sailcraft, hovercraft, and spacecraft.

3. The vehicle cover of claim 1, wherein the animate object comprises at least one of a human, animal, and plant.

4. The vehicle cover of claim 3, wherein the human comprises a celebrity.

5. The vehicle cover of claim 3, wherein the animal comprises one of a dog, cat, mouse, fish, whale, shark, eagle, ladybug, bear, and dinosaur.

6. The vehicle cover of claim 3, wherein the plant comprises one of a flower and fruit.

7. The vehicle cover of claim 1, wherein the inanimate object comprises a fictitious character.

8. The vehicle cover of claim 7, wherein the fictitious character comprises a cartoon character.

9. The vehicle cover of claim 8, wherein the cartoon character comprises one of Tweedy Bird and Sylvester.

10. The vehicle cover of claim 7, wherein the fictitious character comprises a motion picture character.

11. The vehicle cover of claim 1, wherein the one or more feature comprises one or more surface ornamentation.

12. The vehicle cover of claim 11, wherein the one or more surface ornamentation comprises one or more drawing.

13. The vehicle cover of claim 1, wherein the one or more feature comprises one or more component.

14. The vehicle cover of claim 13, wherein the one or more component comprises at least one of an eye, nose, ear, hand, leg, foot, paw, and tail.

15. The vehicle cover of claim 13, wherein the one or more component is coupled with the vehicle cover via at least one of stitches, zippers, buttons, and Velcro.

16. The vehicle cover of claim 15, wherein the one or more component further comprises at least one of wires and piping whereby said one or more component projects outwardly to further enhance the distinctive image.

17. The vehicle cover of claim 1, wherein the vehicle cover comprises at least one of a textile, leather, and polymer.

18. The vehicle cover of claim 17, wherein the at least one of a textile, leather, and polymer is further at least one of UV-resistant, waterproof, and weather-resistant.

19. A method of making a vehicle cover comprising providing a vehicle cover comprising one or more feature wherein the one or more feature provides a distinctive image of at least one of an animate and inanimate object when the vehicle cover is deployed.

20. A method of covering a vehicle comprising covering a vehicle with a vehicle cover comprising one or more feature wherein the one or more feature provides a distinctive image of at least one of an animate and inanimate object when the vehicle cover is deployed.
